(19) United States
(12) Patent Application Publication
(10) Pub. No.: US 2008/0288162 A1
(43) Pub. Date: Nov. 20, 2008

(54) Combined short range and long range communication for traffic analysis and collision avoidance

(75) Inventors: Wolfgang Theimer, Bochum (DE); Mohsen Darianian, Lohmar (DE); Edmund Coersmeier, Bochum (DE); Marc Hoffmann, Dinslaken (DE)

Correspondence Address: Ware, Fressola, Van Der Sluys & Adolphson LLP, 755 Main Street, P.O. Box 224, Monroe, CT, 06468, US

(73) Assignee: Nokia Corporation

(21) Appl. No.: 11/804,307

(22) Filed: May 17, 2007

(51) Int. Cl. G08G 1/16

(52) U.S. Cl. 701/117; 701/301

(57) ABSTRACT

A method and system for combining short range communication and long range communication for traffic related applications is presented. In one example, a central server is equipped and configured to receive information via long range communication from one or more individual traffic objects, analyze the received information to determine the short range communication needs, if any, between an identified subset of traffic objects and then initiate short range communication between the traffic objects in the identified subset of traffic objects.

### TECHNICAL FIELD

The present invention relates generally to traffic-related applications, and deals more particularly with the combined usage of long range and short range communication in such traffic related applications for building up knowledge about the traffic environment around traffic objects.

### BACKGROUND OF THE INVENTION

The driving or automobile traffic density continues to grow globally resulting in increased traffic congestion, slow moving or otherwise impeded traffic flow and an increased probability of encountering an accident or collision. This increased traffic density has led to a number of developments addressing traffic related concerns including avoiding collisions. Generally, collision avoidance systems are autonomous, i.e. they actively or passively sense the environment, for example, by infrared or radar, and measure the reflected signals to sense the distance of objects as a function of time based on their sensor feedback to evaluate the probability of a collision to warn the user if one or more traffic objects/subjects are on a collision course. This task is challenging because the distance estimation solutions are error-prone and traffic objects might not be sensed at all for example due to occlusion. The traffic and collision information evaluation can also become quite demanding in this scenario if multiple traffic objects/subjects have to be tracked in the vicinity of a traffic object or obstacle. Further, it is very difficult to make a proper scene traffic analysis to identify other traffic objects/subjects which should also be taken into account in the traffic and collision information evaluation.

What is needed is a way to evaluate traffic and collision information taking into account the multiple traffic objects/subjects including people in the vicinity of interest or concern that overcomes the drawbacks and disadvantages of autonomous collision avoidance and traffic analysis systems.

### SUMMARY OF THE INVENTION

In accordance with a broad aspect of the invention, short range communication is combined with long range communication for traffic related applications. In a further aspect, a central server is equipped and configured to receive information via long range communication from one or more individual traffic objects, analyse the received information to determine the short range communication needs, if any, between an identified subset of traffic objects and then initiate short range communication between the traffic objects in the identified subset of traffic objects.

### BRIEF DESCRIPTION OF THE DRAWINGS

Other objects, features and advantages of the present invention will become readily apparent from the written description taken in conjunction with the drawings in which like reference numbers refer to like parts wherein:

FIG. 1 is a functional schematic representation showing an example of a system for wireless communication for traffic analysis and collision avoidance embodying the present invention.

FIG. 2 is a functional schematic flow chart showing one example of the method of the present invention.

FIG. 3 is a functional schematic flow chart showing another example of the method of the present invention.

FIG. 4 is a functional schematic flow chart showing a further example of the method of the present invention.

FIG. 5 is a functional schematic flow chart showing the method of distributed processing of traffic and collision information in the present invention.

FIG. 6A shows a representation of a local map.

FIG. 6B shows a representation of the position of vehicles and objects that are shown on the local and global maps.

FIG. 6C shows a representation of a global map.

FIG. 7 shows a schematic representation of an occluded pedestrian as viewed from the perspective of the driver and vehicle.

FIG. 8 shows a schematic representation of an ad-hoc wireless network linking cameras in vehicles to provide an enhanced traffic scene.

FIG. 9 is a schematic functional block diagram of an example of a collision detector that may be utilized to carry out the operational functions of the present invention.

FIG. 10 is a functional block diagram of an example of a signal processor for carrying out the invention.

FIG. 11 is a functional block diagram of an example of a central server for carrying out the invention.

### WRITTEN DESCRIPTION OF EMBODIMENTS OF THE INVENTION

As used in the description of the invention herein, the term traffic object may refer to any of a number of traffic associated structures, devices or fixed objects such as for example, traffic surveillance cameras, speed sensors, counters, directional sensors, obstacles, and other well know and recognized fixed traffic-related structures or devices. The term traffic object may also refer herein to any of a number of moving traffic articles or things such as for example vehicles, pedestrians, trains, bicycles, all-terrain vehicles, tractors, user powered devices, scooters, and other well known and recognized moving traffic-related articles or things.

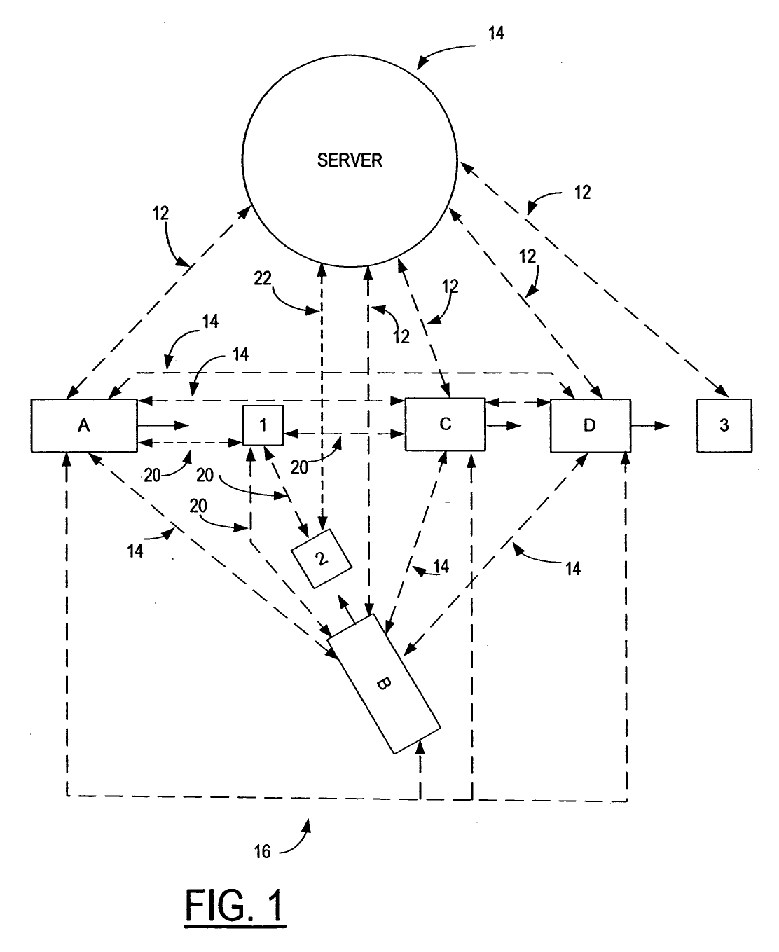

Turning now to the drawings and considering the invention in further detail, a functional schematic representation of one example of a system embodying the invention for providing the combined usage of long range and short range communication in traffic-related applications, such as for example, traffic analysis and collision avoidance is shown in FIG. 1. In this example, it is seen that the network architecture of the invention is made up of long range/cellular communication shown by communication paths 12, 12 supported by a central server 14 in combination with short-range communication shown by the communication paths 14, 14 between the individual traffic objects A, B, C, D. The communication between the traffic objects A, B, C, D may be one-to-one or networked over an ad-hoc short-range communication network shown generally 16 or in any combination as described herein. Other traffic objects 1, 2, 3 may also be present and provide an indication of their presence and positional location such that their information is also made available to the traffic objects A, B, C, D and the central server 14 for use in providing traffic analysis and collision avoidance.

Each of the traffic objects may include short range and/or long range communication capability as required to carry out and implement the intended functions of the invention. For example and still referring to FIG. 1, the position and/or location of a fixed traffic object 1, such as a fixed surveillance camera without long range communication capability might be known to the central server 14. The fixed traffic object may however only be equipped and configured with short range communication capability to initiate in response to a suitable initiation triggering event short range communication over the communication paths 20, 20, using for example short range radio communication technology, with local traffic objects A, B, C or another traffic object 2. The traffic object 2, for example a further surveillance camera, in turn might be equipped and configured with long range communication technology for delivering video or fixed image information such as pictures to the central server 14 over a long range communication path 22. The central server 14 may provide the received video or fixed image information to other traffic objects D, 3 or may initiate short range communication between identified traffic objects for example traffic objects A, B.

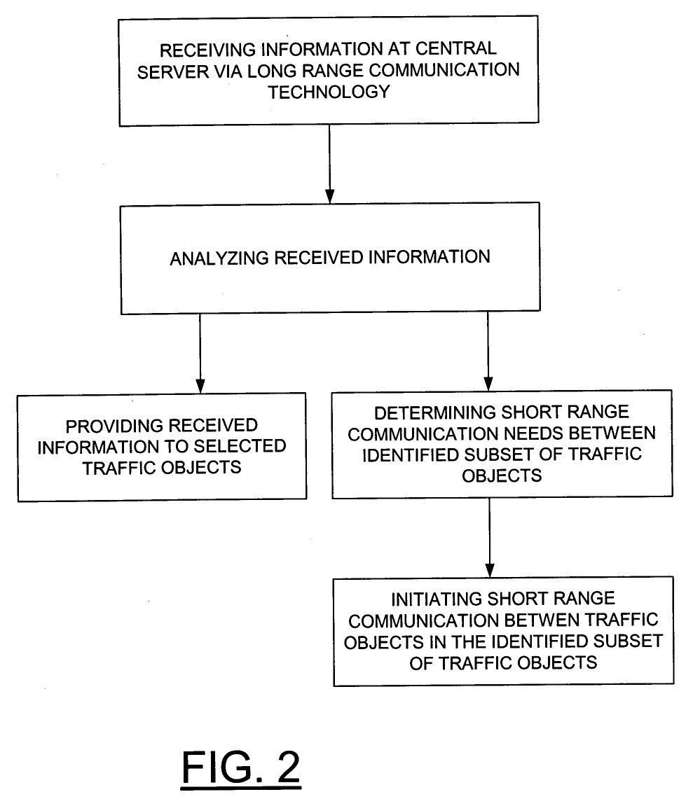

In other words, in a broad example of the invention as illustrated in the functional flow chart in FIG. 2, the central server 14 is equipped and configured to receive information via long range communication from one or more individual traffic objects providing their respective information for example, position, speed, trajectory, analyse the received information to provide it to selected traffic objects and/or to determine the short range communication needs, if any, between an identified subset of traffic objects (those being potentially affected) and then initiate short range communication between the traffic objects in the identified subset of traffic objects.

It should be apparent that the combination of short range and long range communication for traffic related applications as described above may be utilized together with suitable software for traffic analysis applications to provide local or general traffic control, traffic jam or congestion avoidance or dispersement, or altering of traffic routes by detecting and taking appropriate action to accommodate the current street conditions, for example construction activity on or along a street route that may effect or impede traffic flow, including temporary lane changes along the street route and conveying the appropriate information to those traffic objects being potentially affected.

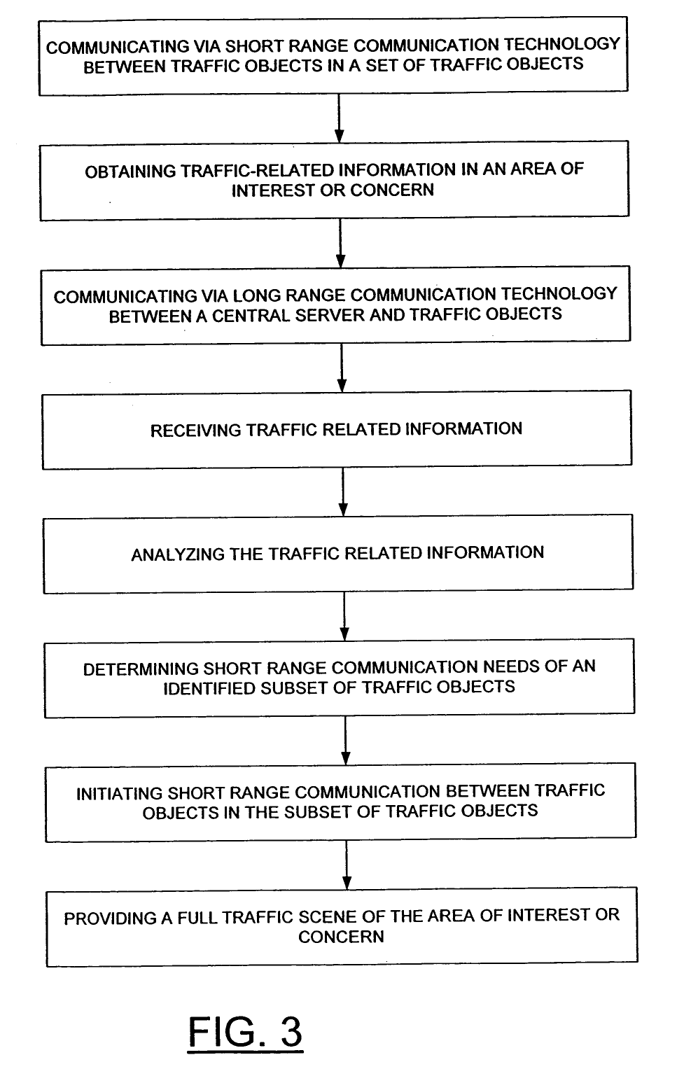

The method of another broad example of the invention is shown in the functional schematic functional flow chart in FIG. 3 in which one or more traffic objects in a random set of individual traffic objects have established initial communication via short range communication technology between one another for obtaining traffic-related information in an area of interest or concern. A central server communicates with one or more of the individual traffic objects via long range communication technology for receiving the traffic related information. The traffic objects do not necessarily need to be connected in the first step via a short range communication technology for obtaining traffic related information but might simply provide their own position, velocity and trajectory to the central server via the long range communication technology. The traffic related information is analyzed by the central server to determine the short range communication needs between an identified subset of traffic objects which may include one or more traffic objects not included in the random set of individual traffic objects in response to the traffic information analyzed by the central server. Short range communication is initiated between the traffic objects in the identified subset of traffic objects to provide a full traffic scene of the area of interest or concern.

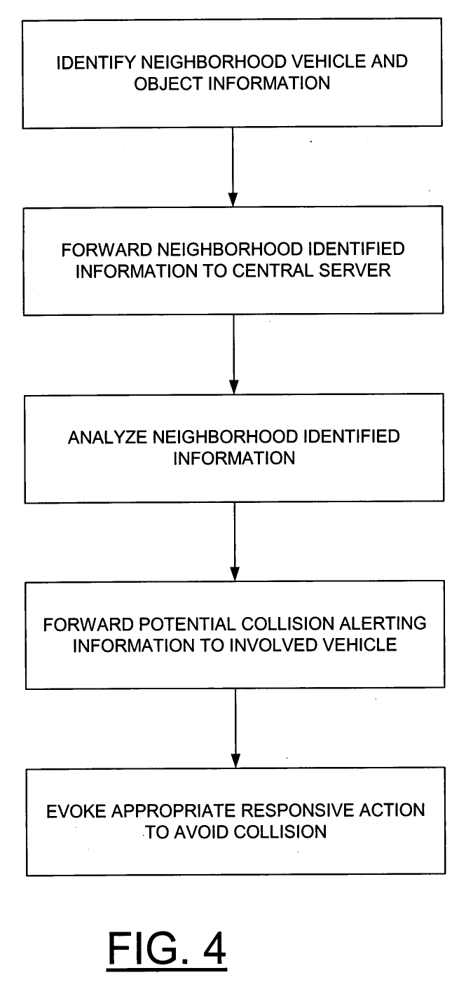

A further broad example of the method of the invention is shown in the functional schematic flow chart in FIG. 4 in which traffic-related object information in the neighborhood of the area of interest or concern is identified and forwarded to the central server for analyzing and evaluating to determine if a traffic condition exists or might develop that would lead to a collision. If it is determined that there is a probability of a collision, a suitable collision alerting information or warning is forwarded to the involved traffic object or traffic objects to evoke an appropriate responsive action to avoid the collision. It will be appreciated that the traffic information may be sent from each individual traffic object via long range communication technology to the central server or collected by one or more individual traffic objects via short range communication technology and then forwarded to the central server as appropriate to carry out the intended function.

The main advantage of the long range/cellular communication between traffic objects is that all traffic objects can deliver sensor data, particularly positioning data to the central server 14 and the central server 14, which typically suffers from delays on the communication line, can build up an overall traffic scenario. The server can request the individual traffic objects to make short-range radio contact with other identified traffic objects even before the traffic objects know that other traffic objects are in proximity to them for purposes of exchanging further sensor data for use in collision avoidance and traffic analysis. The request can be made using any suitable communication mechanism, for example, short range radio identification (ID) information for fast connection set-up.

The present invention may be implemented with currently known or future developed short range and cellular communication technologies or other suitable communication technologies capable of carrying out the intended functions. For purposes of explanation, the invention is described herein using short-range radio and cellular communication technologies such as for example, Bluetooth, wireless local area network (WLAN), dedicated short-range communication (DSRC) and infrared. Examples of cellular/long range radio technologies include for example, global system for mobile communication (GSM), universal mobile telecommunication services (UMTS) and general packet radio service (GPRS/3G). Also broadcasting technologies based on for example, Digital Video Broadcasting (DVB), FM Radio, Digital Audio Broadcasting (DAB) may be used to deliver information to the vehicles without the time delays that are inherent to two-way cellular communication technologies. The combination of these short-range and long range communication technologies form the basis for systems embodying the invention.

For purposes of explanation of the invention there is at least one traffic object that exists that collects the information about other traffic objects in the neighborhood in the area of concern or interest and knows its own position and trajectory. The information collector is referred to as a “collision detector” herein. In addition to the at least one collision detector, there are a variable number of other collision detectors in the environment that can be queried to provide their own respective positions and trajectories. A global positioning system (GPS) receiver can provide relative position and velocity information, but any other positioning technology suitable to carry out the intended functionality is also contemplated. It is anticipated that in the future a majority of devices such as mobile terminals will have a highly accurate positioning system for example, GPS/Glonass/Galileo and short-range communication and features for example, WLAN or DSRC in car domain and long-range communication such as packet data via cellular. It is also anticipated that map data is available either from onboard navigation solutions or as local downloads from a server.

One function of the collision detector is to evaluate if any collision detector trajectory is leading to a potential collision with the detector itself by extrapolating motion information and taking into account the position uncertainty due to changes in the trajectory. The collision detection works in the local vicinity or area of interest or concern because only the closely positioned traffic objects are relevant for collision avoidance. If a potential collision is determined, the user of the collision detector is warned or an appropriate collision avoidance behavior is triggered. In addition all affected traffic objects are warned as well via a wireless communication link.

The collision detector can be implemented as an accessory or can be integrated into a mobile terminal. It is important that the collision detector has the ability to compute the possible collisions based on the information it receives and/or requests.

Some of the traffic objects due to their nature and functionality, can have a simpler design than the collision detector. The basic requirement is that the traffic object reveal its position/motion. A collision detector can of course also be a traffic object sending out positioning information to other collision detectors.

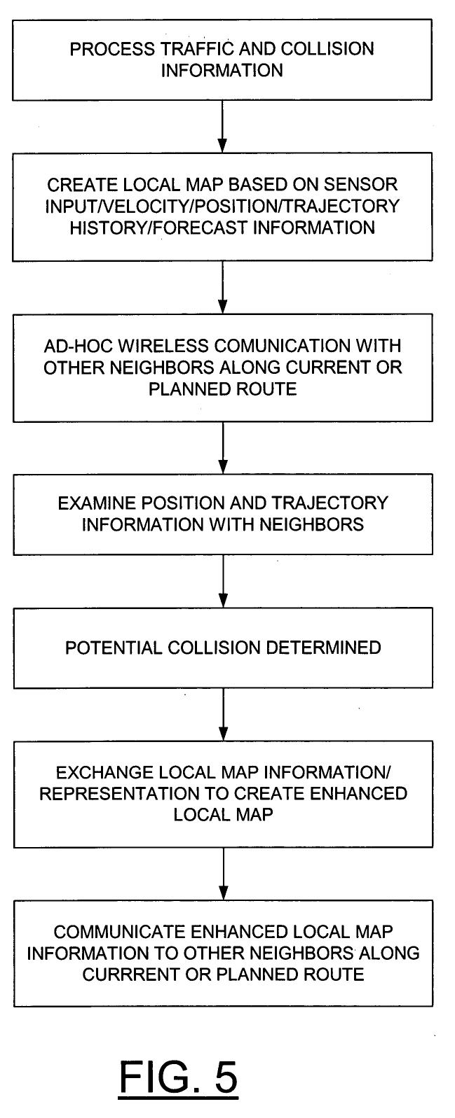

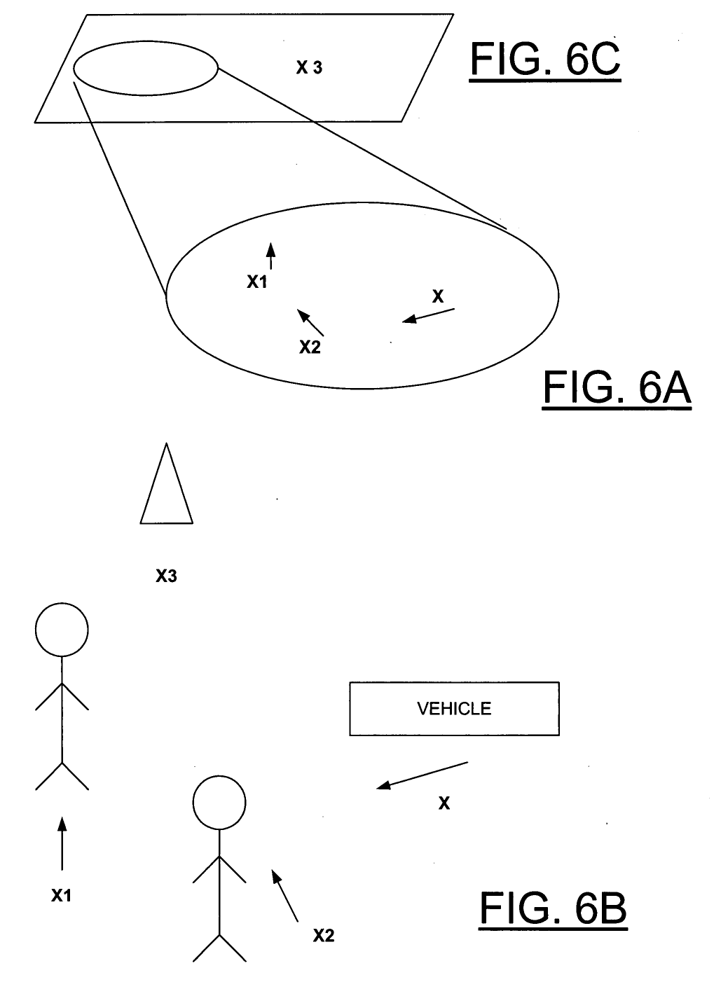

The processing of traffic and collision information as illustrated in the functional flow chart shown in FIG. 5, takes place in a distributed cooperative manner. Collision detectors can create local maps as shown for example in FIG. 6A based on their sensor input plus position/velocity/trajectory history and forecast information in which the collision detectors such as shown in FIG. 6B transmit their current positions to a global map as shown for example in FIG. 6C. A server aligns the positions of the collision detectors with street models on the map based on the accumulation of individual position estimates. Strong traffic patterns will emerge for different categories of streets (e.g. differing in velocity), sidewalks and other areas on the map. Due to occlusion and other effects the traffic objects cannot sense the complete environment, but communicate with other traffic objects to get and send a more complete representation of the environment.

The collision detectors can concentrate on other collision detectors that are in a corridor around the current or planned route. So the ad-hoc communication between local collision detectors includes a first step where positions and trajectory information are exchanged. Only if collision detectors might potentially collide, representations of the local collision detectors are exchanged to create a more complete 3-dimensional model of the scene.

The processing is done hierarchically: The local processing consolidates the information from neighbor collision detectors before sending the results to other collision detectors or a central server. The global map guides the communication between local collision detectors by pointing out or identifying potential communication partners. Additionally the local collision detectors can scan their environment for other communication partners.

The invention may be implemented in a centralized server-based wireless communication system such as shown above in FIG. 1 in which each collision detector measures its position and motion trajectory and updates its information frequently on a server. The collision detector contacts this server and compares all registered location information with its own position and trajectory.

The advantage of a centralized server-based communication system is that collision detector information is available for multiple collision detectors in parallel, however an always-on connection is needed to a central server. The server is further constantly accessed by a very large number of collision detectors because the update frequency needs to be high for example on the order of seconds to take into account the changing position of the collision detector.

A central global map can also be used to include fixed traffic objects, i.e. stationary obstacles for example, walls, fences, etc. and to distribute the location/position of the stationary obstacle to the collision detectors without having the need to equip those stationary obstacles with any transponders or other electronics.

The invention may be implemented in a peer-to-peer wireless communication system in which the collision detector queries all collision detectors in its vicinity or area of concern or interest and aggregates their respective positions/trajectory information in its own local map of the surroundings.

The advantage of a local peer-to-peer based wireless communication system is that it does not depend on the reliability of a central server however, it is not optimal because every collision detector has to maintain its own local map of the surroundings even though the differences with respect to a neighboring collision detector local map might be small and not consequential.

The invention may be implemented in a global server-based and local peer-to-peer based wireless communication system which allows the collision detector to get a complete overview of more distant collision detectors and the update frequency to the server can be on the order of seconds because these more distant collision detectors or objects are not as relevant to the immediate traffic situation. However, in the local vicinity it is important to have a short reaction time to new traffic situations that develop. Here a direct peer-to-peer communication and sensing of the distance to other collision detectors with higher update frequency is beneficial without involving a central server in which the update frequency would be too slow to warn of an impending collision with nearby collision detectors.

The global server based and local peer-to-peer based wireless communication system represents a synthesis of server-based and peer-to-peer approaches by combining longer distance global maps with lower update frequency and local distance maps which are collected by peer-to-peer communication with a higher update frequency. This approach is needed because even pedestrians can achieve a velocity of more than 6 meter/second. With a global positioning system (GPS) update frequency of 1 Hertz, a displacement of 6 meters can occur before the pedestrian's position is updated. The distance covered by the pedestrian would be large enough to cause a serious accident if a pedestrian, for example, a child, leaves the sidewalk and crosses the street without noting the ongoing traffic. In the case of motor-driven vehicles, the velocity is typically higher and thus vehicle displacement also requires a higher update frequency than possible with a central server.

Public and individual privacy policy considerations and laws do not allow traffic objects or people to be tracked continuously over a certain period of time which would otherwise allow tracking the people carrying “collision sender” devices to identify themselves as traffic objects. Therefore, the identification data of a traffic object that makes it unique and addressable is continuously changed to provide anonymous communication to prevent tracking but yet allow the system to know the traffic object is there. In the ideal case the identification data is changed for every query to complicate tracing of traffic objects over time.

The invention might classify collision detectors according to their individual motion pattern or based on a user setting such as for example, pedestrian, biker, car driver, motorcyclist. At least the categories of higher velocity traffic objects eg. motor-driven vehicles, cars, buses, motorcycles, slower velocity traffic objects eg. bicycles, pedestrians, etc and stationary traffic objects e g. obstacles such as walls, etc. should be distinguished as each category requires a different guidance strategy for collision avoidance.

A collision detector in a high velocity vehicle should only need to monitor the region ahead and partly to the left and right of it in the direction it is traveling, but it can neglect or ignore the backwards direction unless the vehicle is moving in the backwards direction. The collision detector should monitor other higher velocity collision detectors in particular since they have the highest collision probability. A potential displacement from or leaving the street lane itself is monitored and leads to a warning for the driver. Also other potential collisions with stationary obstacles or people are also important to detect.

A collision detector in a low velocity traffic object provides a collision warning that depends on the exact traffic scene classification. If a pedestrian is on a sidewalk a warning should only be issued if the pedestrian is entering the actual street area and has not checked potential traffic in both directions or there is a clear danger of a collision or accident. Determining if a user has checked traffic can be done with a direction sensor, which detects the angular displacement compared to the magnetic north pole. The sensor might be attached to the user's head in order to sense the viewing direction of the pedestrian. This viewing direction information is compared to the street model in the collision detector to evaluate if the pedestrian might be aware of oncoming traffic objects by knowing whether or not the pedestrian has looked in the direction of the oncoming traffic object. A suitable warning or alerting indication is issued to the traffic object or the pedestrian or both if there was no attempt to look in all street directions.

A collision detector integrated in a stationary obstacle for highly dangerous hotspots (for example, difficult street crossings) should not be necessary with the present invention because the collision detector travels with the person.

Since the system requires a scan of the environment extending to more than 100 meters around the collision detector it is also necessary that traffic objects likewise cover these distances and therefore currently known passive technologies such as RFID are not suitable for use in the individual traffic objects. Suitable active technologies, that is, battery-powered devices that evaluate their own respective positions, align the position with possible map data and transmit their positions/trajectories via a short-range communication technology using for example a wireless standard such as, WLAN or DSRC to neighboring traffic objects are used to provide the necessary distance scanning. A packet data connection to a central server via GPRS/3G or another suitable wide-range cellular communication standard may be used to update a global map and to read the positions of neighboring traffic objects.

The system for wireless communication for traffic analysis and collision avoidance of the invention may further utilize video information from cameras or other imaging capable devices that are networked together via the ad-hoc wireless short-range network to provide a further robust traffic scene analysis. Currently a number of vehicles are equipped with one or more cameras to assist the driver of the vehicle to view the surroundings such as when backing up the vehicle to identify or warn of hidden obstacles or people. These cameras are able to monitor the traffic situation in addition to what the driver is able to monitor. Software in the background is able to analyze the video sequences and pictures and warns the driver in case of emergency situation, for example, that pedestrians are crossing the road. These cameras are only able to screen the traffic scenario from the driver or vehicle's perspective for example as illustrated schematically in FIG. 7 in which vehicle 2 is only able to identify pedestrian 1. The vehicle 2 camera cannot see the pedestrian 2 because the pedestrian 2 is hidden by pedestrian 1 when considering the vehicle 2 perspective. The pedestrian 2 is visible for vehicle 1 whereas vehicle 1 cannot see the pedestrian 1.

Now vehicle 2 might plan a change maneuver, which avoids the visible pedestrian 1 but the vehicle 2 change maneuver might not take the pedestrian 2 into account. Thus after vehicle 2 has evaded pedestrian 1 it might hit or collide with the pedestrian 2 who was not visible for vehicle 2 before the change maneuver, but was visible from vehicle 1. It would have been advantageous if vehicle 1 informed vehicle 2 about the existence and walking speed/direction of the pedestrian 2 without an extra request from vehicle 2.

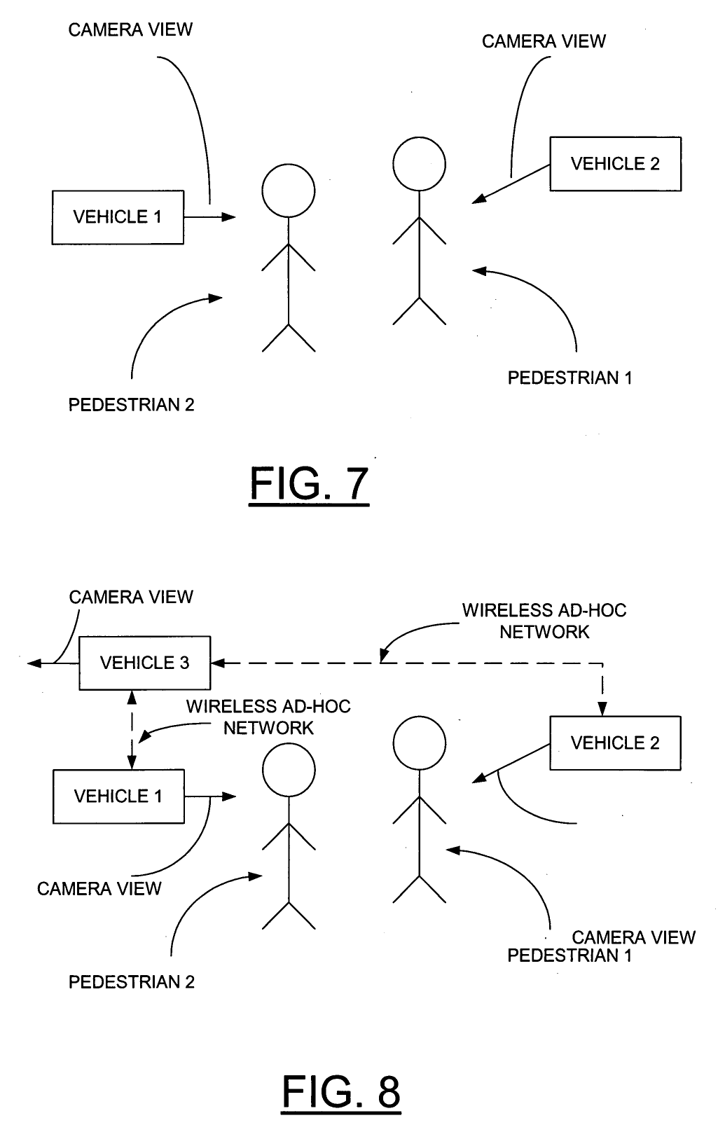

As illustrated in FIG. 8, vehicle 1 communicates the information about the pedestrian 2 to vehicle 2 and vehicle 3 traffic software via the ad-hoc wireless network. Vehicle 2 traffic software is able to combine the information from vehicle 1 together with its own camera information and starts to recognize that behind the pedestrian 1 there is additionally the pedestrian 2 that was occluded by the pedestrian 1. Vehicle 3 identifies and determines that vehicle 1 traffic information is not relevant because vehicle 3 is driving in a different direction. However, vehicle 3 still has an important role in the overall situation by building a communication node in the ad-hoc wireless network, to transfer the information from vehicle 1 to vehicle 2.

The wireless network is a self-organizing wireless network, which is able to act independently of any central server/master communication node. Each camera builds a node in the wireless network. This means that the camera in the vehicle or integrated into a mobile terminal connects itself automatically to another camera's wireless link.

Each wireless camera provides the photo, image or video information as well as the vehicle speed, GPS information, distance to other vehicles or traffic objects, driving direction, and other relevant information as discussed above to all other wireless network nodes.

Each network node, which receives all other camera information, forwards its own as well as the received information from other vehicle cameras to other network nodes. Depending on its own geographic position and the positional information of where the other vehicles are driving, the network node in one vehicle can decide, which information is important, and which information is unimportant to evaluate as well as information to send further on to other vehicles. After the corresponding information is collected from all other vehicle cameras, a suitable 3-dimensional graphic software starts to put together all 2-dimensional image information and to convert those to one 3-dimensional image information. The 3-dimensional image can be used to identify traffic dangers, which are not visible at that moment from the vehicle's own camera perspective.

Additional cameras that might be installed on house roofs or next to the streets can offer additional information for use in the traffic analysis and collision avoidance when the cameras are connected to an ad-hoc short range communication wireless or other suitable short range communication network. It should be recognized that the cameras may also be arranged and configured to communicate via long range communication technology with a central server in a manner as described above to combine short range and long range communication to send image and video information to provide a full traffic scene in an area of interest or concern.

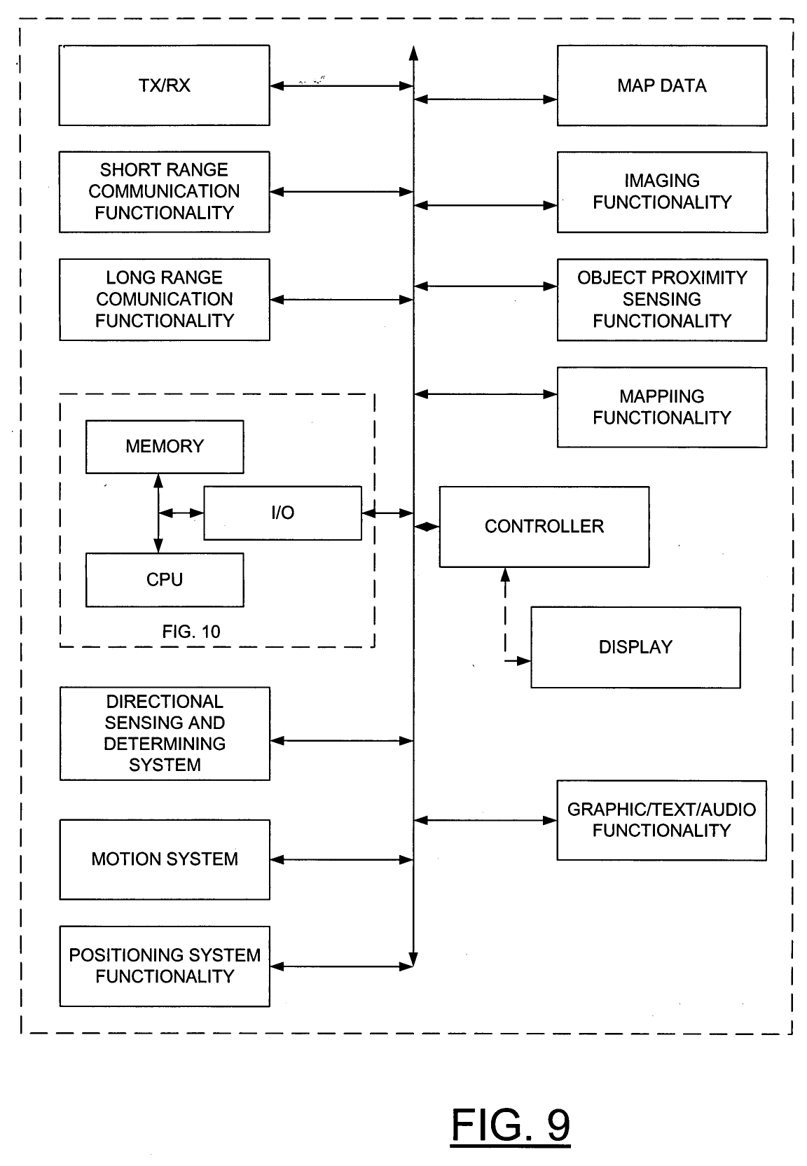

FIG. 9 is a schematic functional block diagram showing an example of a collision detector that may be utilized to carry out the operations and functions of the present invention as described above. The collision detector may include a suitable display for showing text/graphics/video or may be arranged and configured for connection to an external display using a suitable connection technology such as hardwired, short range communication including Bluetooth and other well known technologies to carry out the intended function.

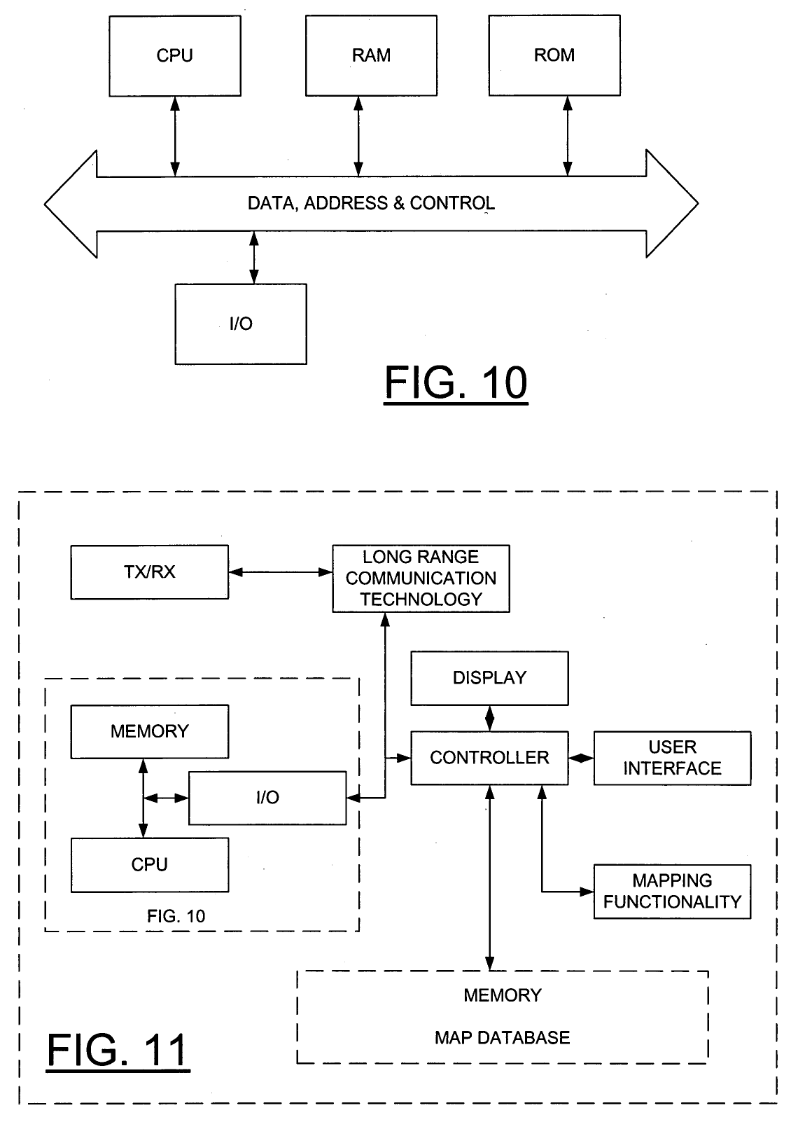

The interactions between the major logical functions should be obvious to those skilled in the art for the level of detail needed to gain an understanding of the concept of the present invention. It should be noted that the concept of the invention may be implemented with an appropriate signal processor such as shown in FIG. 10, a digital signal processor or other suitable processor to carry out the intended function of the invention.

FIG. 11 is a functional block diagram of an example of a central server configured and arranged with suitable long range communication technology for carrying out the functions of the invention.

The functionality described above can be implemented as software modules stored in a non-volatile memory, and executed as needed by a processor, after copying all or part of the software into executable RAM (random access memory). Alternatively, the logic provided by such software can also be provided by an ASIC (application specific integrated circuit). In case of a software implementation, the invention can be provided as a computer program product including a computer readable storage structure embodying computer program code—i.e. the software—thereon for execution by a computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

1. A system, comprising:
a plurality of individual traffic objects within a group of traffic objects being configured for communication with one another over short range communication technology; and
a central server configured for communication with one or more of said plurality of individual traffic objects over long range communication technology, said central server being configured for receiving information from one or more of said plurality of individual traffic objects, analyzing said received information, determining short range communication needs between an identified subset of traffic objects and initiating short range communication between said identified subset of traffic objects.

2. The system as defined in claim 1 further comprising the central server receiving sensor data information from one or more of said individual traffic objects.

3. The system as defined in claim 1 further comprising the central server receiving information for initiating ad-hoc short range communication between traffic objects.

4. The system as defined in claim 1 further comprising initiating ad-hoc short range communication between traffic objects via short range radio identification (ID) information.

5. The system as defined in claim 1 further comprising the central server sending short range radio identification (ID) information to the identified subset of traffic objects for the traffic objects short range communication.

6. The system as defined in claim 2 wherein said sensor data information includes information about others of said plurality of individual traffic objects within said sensor sensing distance of a said individual traffic objects and information about the position and trajectory of said individual traffic object.

7. The system as defined in claim 1 wherein said individual traffic object is configured to request and accumulate sensor data information from others of said plurality of individual traffic objects.

8. The system as defined in claim 1 wherein said individual traffic object is configured to evaluate if an individual traffic object trajectory is on course leading to a potential collision with said individual traffic object.

9. The system as defined in claim 4 wherein one or more of said plurality of individual traffic objects are configured and arranged with imaging capability to sense individual traffic objects within said sensor sensing distance of a said individual traffic object to provide in real time a graphic representation of said individual traffic objects within said sensor sensing distance in said area of interest or concern.

10. The system as defined in claim 9 wherein said real time graphic representation is shared with others of said plurality of individual traffic objects over said ad hoc short-range communication network.

11. Method, comprising:
communicating via long range communication technology between a central server and one or more traffic objects in a set of individual traffic objects for receiving the traffic-related information;
analyzing the traffic-related information;
determining the short range communication needs between traffic objects in an identified subset of individual traffic objects; and
initiating short range communication between traffic objects in said identified subset of individual traffic objects for providing a complete traffic scene of the area of interest or concern.

12. The method as defined in claim 11 comprising the central server receiving sensor data information from one or more of said individual traffic objects.

13. The method as defined in claim 11 comprising the central server receiving sensor data information from one or more of said individual traffic objects each of which has collected sensor data information from one or more of others of said individual traffic objects, the central server initiating ad-hoc short range communication between others of said traffic objects in an identified subset of individual traffic objects.

14. A computer program product comprising a computer readable storage structure embodying computer program code thereon for execution by a computer processor, wherein said computer program code comprises instructions for performing a method according to claim 11.

15. An application specific integrated circuit configured for operation according to claim 11.

16. Apparatus, comprising:
a traffic object arranged with a suitable short-range communication technology and a suitable long range communication technology, configured for providing traffic related information via said long range communication technology and further configured for receiving instructions via said long range communication technology for initiating short range radio communication with other traffic objects.

17. The apparatus as defined in claim 16 comprising said traffic object further
configured for long range communication with a central server.

18. Apparatus, comprising:
a traffic object arranged with a suitable short-range and/or a suitable long range communication technology and with at least one camera for image and/or video capturing functionality configured for receiving further image/video information via said short range communication technology and/or said long range communication technology and for computing said captured and said received image/video information for generating a traffic scene around said traffic object.

19. Apparatus as defined in claim 18 wherein said traffic object is further configured for transmitting and/or receiving further sensor information including one or more of speed, position and distance to other traffic objects.
